(19) United States
(12) Patent Application Publication
(10) Pub. No.: US 2012/0012226 A1
(43) Pub. Date: Jan. 19, 2012

(54) DEVICE AND METHOD FOR MIXING BEVERAGES

(75) Inventors: Torsten Runge, Straubing (DE); Dirk Leutz, Ergoldsbach (DE); Matthias Weinzierl, Eching (DE)

(73) Assignee: KRONES AG, Neutraubling (DE)

(21) Appl. No.: 13/111,562

(22) Filed: May 19, 2011

(30) Foreign Application Priority Data
May 19, 2010 (DE) 102010029125.0

(51) Int. Cl. B67D 7/74

(52) U.S. Cl. 141/9; 141/94; 141/100; 141/82

(57) ABSTRACT

A device and method for the mixing of a beverage where, due to the fact that an aqueous mixed phase, in which the recipe constituents needed for mixing the beverage are contained and which has a higher water content than the prepared mixed beverage, is collected in a tank, the mixed phase can be added specifically to a beverage mixture of excess concentration in order to adjust the desired final concentration. The mixed phase preferably contains returned proportions of the prepared mixed beverage.

### CROSS-REFERENCE TO RELATED APPLICATION

The present application claims the benefit of priority of German Application No. DE 102010029125.0, filed May 19, 2010. The entire text of the priority application is incorporated herein by reference in its entirety.

### FIELD OF THE DISCLOSURE

The disclosure relates to a device and method for the mixing of beverages, such as used in beverage filling and bottling operations.

During the mixing of beverages, such as for example a juice or a lemonade, either several recipe constituents are individually added to water, or a prepared basic component, such as for example a beverage concentrate or a syrup, is mixed with water to adjust the desired concentration of the ingredients in the end product.

In this respect it is known from the state of the art, for example, from Blüml S., Fischer S.: “Handbuch der Fülltechnik” [Manual of Bottling Technology], Behr's Verlag, Hamburg, 2004, that a prepared mixed beverage can be fed to a heat treatment unit and temporarily stored in a sterile buffer tank before the beverage is filled. Between the sterile buffer tank and the inlet to the heat treatment unit a return line can be provided, which however can only be used to add heat-treated product to the prepared mixed beverage, for example to move the product in the circuit during an interruption in the production sequence.

During a change between different products or a longer halt in production, the product present in the pipe system must be drained and/or pushed out of the pipes with water. In particular this type of ejected product fraction must then be discarded. With frequent changes of product or the manufacture of small amounts this is uneconomical, both with regard to the product costs and also the waste-water costs.

Therefore there is a requirement for a device improved in this respect and an improved method.

### SUMMARY OF THE DISCLOSURE

In connection with the disclosed device, by a collecting tank for collecting an aqueous mixed phase, in which the recipe constituents for mixing the beverage are contained, and which has a higher water content than the mixed beverage, any proportions of previously mixed product can be combined, for example during the flushing of pipe sections and treatment containers or during the collection of end product which has not been properly sterilized or filled. In a product line for providing a concentrate in which the recipe constituents required for mixing the beverage are contained and which has a lower water content than the mixed beverage, the concentrate and the mixed phase can be mixed in a predetermined mixing ratio to the beverage. The concentrate is preferably the result of a first, preparatory mixing, in which the ingredients of the beverage with the exception of the water content are already present in the same mixing ratio as in the end product. The device according to the disclosure is therefore used for the final mixing by adjusting the desired water content of the beverage. For this purpose a measurement device is provided for measuring the concentration of a characteristic constituent of the mixed phase as well as an additive line connected to the collecting tank and the product line for mix the mixed phase to the concentrate. In this connection a dosing device for adjusting the volumetric mixing ratio of the mixed phase and the concentrate is provided on the additive line. Thus, the additive volume flow of the mixed phase can be adapted to the relevant requirement. The device preferably comprises at least one line for the return of a proportion of prepared mixed beverage.

Preferably, a circulation line is provided on the collecting tank for circulating the mixed phase. In this way temporal variations in the concentration of the mixed phase are reduced.

Preferably, the measurement device is arranged such that it can measure the concentration in the circulated mixed phase. Thus, a particularly accurate detetinination of the concentration is possible.

Preferably, the device according to the disclosure also comprises a measurement device on the inlet end for measuring the concentration of the characteristic constituent of the concentrate and/or a measurement device on the outlet end for measuring the concentration of the characteristic constituent of the prepared, mixed beverage. Thus the control of the mixed phase dosing can be carried out precisely and updated.

Preferably, the device according to the disclosure also comprises a control device for controlling the dosing device based on a concentration value determined by the measurement device on the inlet and/or on the outlet end. In this way the dosing can be automated and adjusted particularly accurately to changing operating conditions.

Preferably, the device according to the disclosure also comprises a return line for returning prepared, mixed beverage from the product line to the collecting tank. Thus product located in the pipe system can he reused in a simple manner.

Preferably, the device according to the disclosure also comprises a return line for returning prepared, mixed beverage and heat-treated beverage from the buffer tank to the collecting tank. Thus, beverage which has already been treated can be reused.

Preferably, the device according to the disclosure also comprises a catchment device, which can be connected to the collecting tank, for catching and returning prepared, mixed beverage filled in bottles or similar containers. Thus, the degree of recycling prepared, mixed product can be further increased.

In connection with the disclosed method, the beverage is mixed by adding the mixed phase to the concentrate, whereby the volumetric mixing ratio of the mixed phase and the concentrate are adjusted in dependence of the concentration measured in the mixed phase in order to adjust the concentration of the characteristic constituent in the mixed beverage to a target value.

Preferably, a volume flow of the added mixed phase is adapted to a volume flow of the added concentrate. A dosage of this nature can be controlled in a simple manner with flow meters and with dosing devices.

Preferably, water is also added in order to adjust the target value. Thus, the target value can be more flexibly adjusted also in the case where the mixed phase is too highly concentrated or depleted.

Preferably, prepared, mixed beverage is returned from a sterile buffer tank and/or a catchment tank for emptying filled containers in the mixed phase. In this way mixed product can be particularly efficiently returned.

Preferably, the measured concentration is a sugar content, in particular a Brix value. Thus, a standardized measurement technique can be employed for a plurality of beverages containing sugar.

Preferably, also the concentration of the characteristic constituent in the beverage concentrate and/or the concentration of the characteristic constituent in the mixed beverage is measured. Thus, the dosage can be particularly accurately controlled.

Preferably, the concentrate and the mixed phase are combined during the mixing of the beverage as continuously flowing dosage lines. Such a continuous feed of the components to be dosed during mixing, which for example can also include a dosage line carrying water, facilitates a continuous product flow and continuous further processing of the beverage.

### BRIEF DESCRIPTION OF THE DRAWINGS

A preferred embodiment of the disclosure is illustrated in the drawing. The following are shown:

FIG. 1 a schematic diagram of a device according to the disclosure; and

FIGS. 2A to 2F selected operating states of the device in FIG. 1.

### DETAILED DESCRIPTION OF THE PREFERRED EMBODIMENT

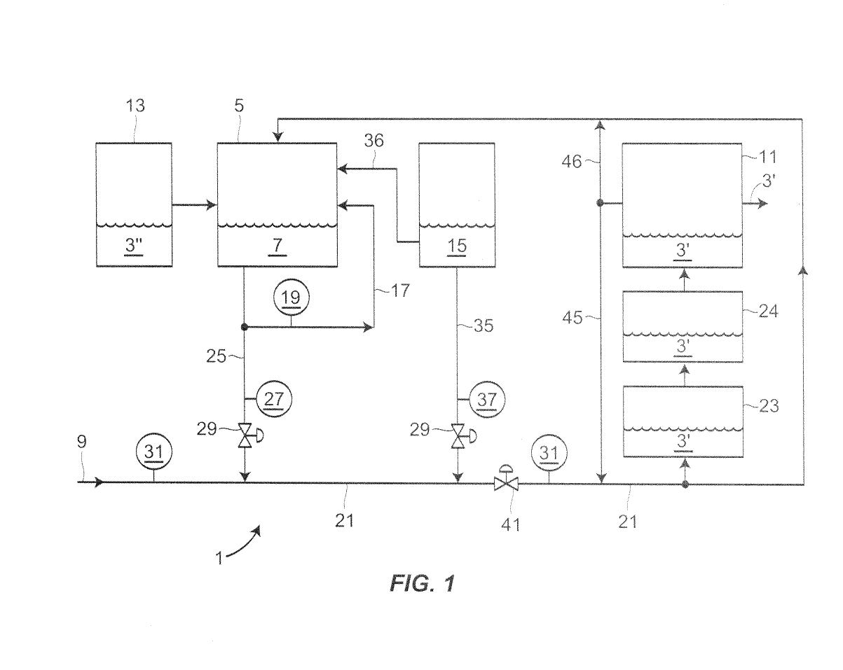

As can be seen from FIG. 1, an embodiment of the device 1 according to the disclosure for mixing a beverage 3 comprises a collecting tank 5 for collecting a mixed phase 7 in essentially a dilution of the prepared, mixed beverage 3. The mixed phase 7 is a mixture of at least two of the following components: A) a premixed beverage concentrate 9, which already contains all the recipe components in a defined composition and is a basic component for mixing the beverage 3; B) ready mixed and heat-treated beverage 3′, which for example is temporarily stored in a buffer tank, in particular in a sterile buffer tank 11, before the beverage is filled; C) ready mixed beverage 3″, which was already filled in bottles and for example is retained in a catchment tank 13 and is temporarily stored; and D) water 15, which can be introduced into the collecting tank 5 after a change of product or halt in production from the pipe system of the device 1 in the form of product water, but also in the form of fresh water.

The beverage concentrate 9 is taken to be an intermediate product mixed in a separate production step which is not shown and which, with the exception of the water content, already corresponds to the prepared mixed beverage 3. Therefore, all recipe constituents to be taken into account during mixing are already present with the exception of the water content in the beverage concentrate 9 in a ratio desired in the end product. The water content, or put differently, the concentration of the beverage 3, is preferably specified based on a characteristic target value, such as the concentration of a characteristic ingredient of the beverage 3 or a suitable characteristic constituent.

During the mixing of beverages 3 containing sugar, such as for example juices, lemonades or syrups, the concentration KA of the mixed beverage 3, the concentration KM of the mixed phase 7 and the concentration KK of the concentrate 9 are preferably specified as sugar content values, in particular as Brix values. The concentrations KA, KM and KK to be considered during mixing and to be monitored by associated measurement devices can however also be characterized by other constituents, ingredients or parameters.

The method according to the disclosure can be realized particularly advantageously if the concentrations KA, KM, KK of the characteristic constituent, preferably the sugar content, in particular the Brix value of the concentrate 9 is 2% to 25% higher than the relevant value of the prepared mixed beverage 3.

The concentration KM of the characteristic constituent, such as for example the sugar content, in the mixed phase 7 can vary depending on the operating state of the device 1 according to the disclosure. As FIG. 1 shows, a circulation line 17 and a measurement device 19 for measuring the concentration KM is provided on the collecting tank 5. Through the circulation of the mixed phase 7 by a pump which is not illustrated temporal variations in the concentration KM are minimized and it is ensured that the concentration KM of the mixed phase 7 introduced into the concentrate 9 for the purpose of mixing the beverage 3 is known and can be applied as an input quantity for the mixing control.

The device 1 also comprises a product line 21 for providing the concentrate 9, for mixing the beverage 3 and for passing the prepared mixed beverage 3 to following treatment units, such as for example the preflow tank 23 of a media supply unit and a following heat exchanger 24 for the heat treatment of the beverage 3. The direction of flow is in each case indicated by arrows. The runoff of the collecting tank 5 is connected to the product line 21 through a mixing line 25 to which a flow meter 27 and a dosing device 29, such as for example a control valve, are provided for adjusting the volume flow VM of the mixed phase 7. The volume flow VM of the mixed phase 7 is an output quantity for the control of the beverage mixing and is adjusted depending on the measured concentration KM of the mixed phase 7 and, where applicable, on further input quantities, namely the volume flow VK and the concentration KK of the fed concentrate 9 such that the beverage 3 preferably is finally mixed after the mixed phase 7 is introduced into the flowing concentrate 9, i.e. such that the beverage 3 is adjusted to the target value of the concentration KA after introducing the mixed phase 7.

As FIG. 1 further shows, the product line 21 comprises a measurement device 31 on the inlet end for measuring the concentration KK of the concentrate 9 and a measurement device 33 for measuring the concentration KA of the mixed beverage 3 on the outlet end. This acts if required as the controlled variable for the mixing of the beverage 3.

In addition, in the flow direction before the measurement device 33 on the outlet end a water feed line 35 for introducing water 15, such as product water or fresh water, into the product line 21 is provided. On the water feed line 35 a flow meter 37 and a dosing device 39, such as for example a control valve, is provided for adjusting the volume flow VW of the water 15 introduced into the product line 21. The water feed line 35 is used to adjust or correct the concentration KA as required, in particular if this is not possible solely by adding the mixed phase 7. This is relevant, for example, when the concentration KM of the mixed phase 7 is too high for correct mixing or during the mixing of the beverage 3 with the collecting tank 5 empty. In this respect it is unimportant whether the water feed line 35 is arranged in the direction of flow before or after the additive line 25. A broken line indicates an optional water supply line 36 for the collecting tank 5.

On the outlet end on the product line 21 a dosage or shut-off device 41 is also provided as well as a first return line 43 for returning prepared mixed beverage 3 or for ejecting product water 15 into the collecting tank 5.

For returning prepared mixed and heat-treated beverage 3′ from the sterile buffer tank 11 to the collecting tank 5 a second return line 45 is provided which can for example open into the product line 21. To facilitate a product circuit from the sterile buffer tank 11 into the collecting tank 5 also without including the product line 21, preferably a third return line 46 is provided to connect the sterile buffer tank 11 directly to the first return line 43 or the collecting tank 5. With the return lines it would be possible where required, for example, to also return heat-treated beverage 3′ from the sterile buffer tank 11 to the input of the treatment unit 23, 24.

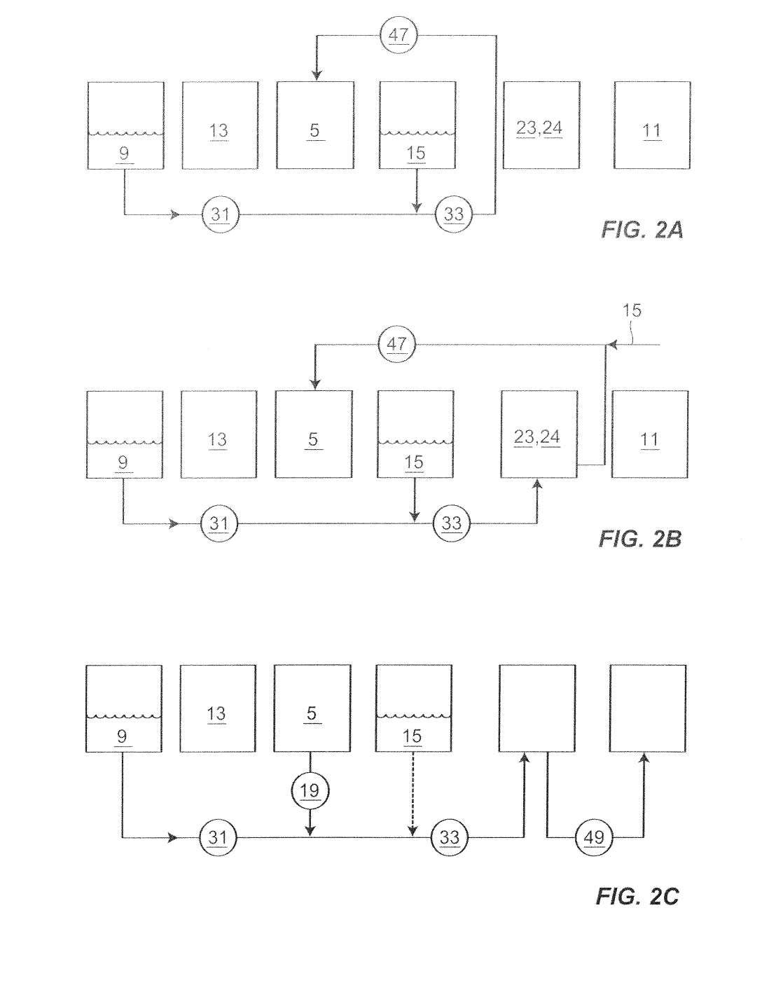

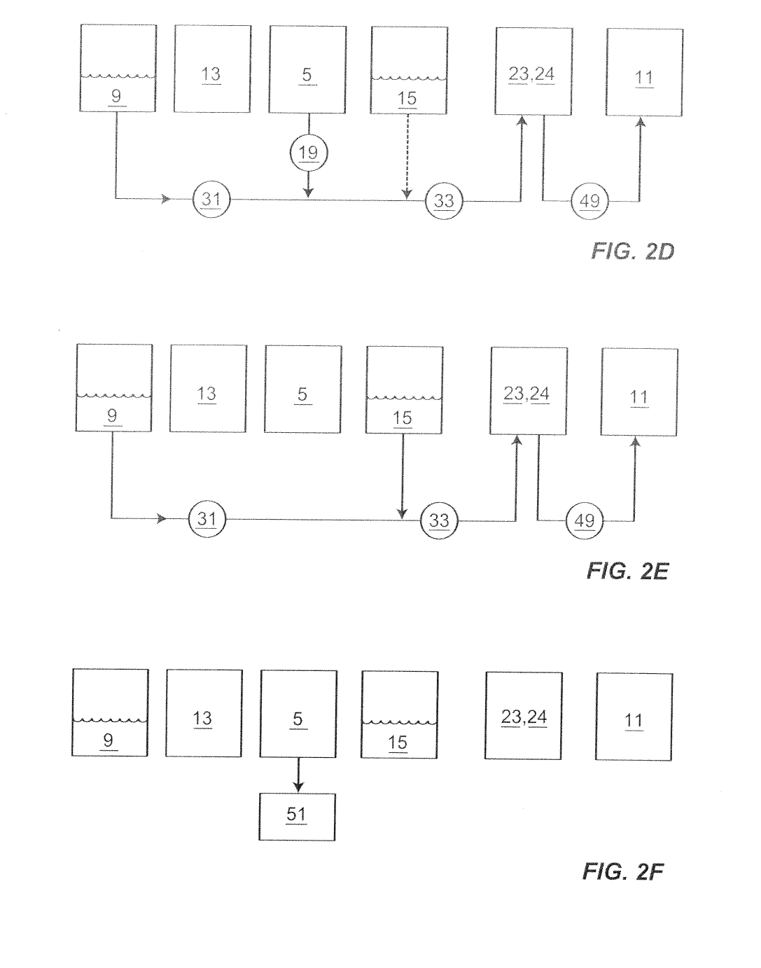

FIGS. 2A to 2F illustrate the method according to the disclosure based on fluid flows in selected operational states of the device 1 according to the disclosure. In this connection, for reasons of clarity individual constituent parts of the device 1 which have been previously described are omitted.

FIG. 2A shows a state of ejecting product water 15, which fills the pipe system of the device 1 between individual product phases and on changing a product, before mixing the beverage 3. For this, concentrate 9 flowing in the product line 21 is mixed with water 15 from the water feed line 35 in the product line 21 and adjusted to the target value of KA such that the product line 21 on the outlet end is filled with the prepared mixed beverage 3 up to a treatment unit such as the preflow tank 23 and the heat exchanger 24. The product water 15 is here ejected into the collecting tank 5. As a supplement to the measurement devices 31 and 33, a measurement device 47 for measuring the characteristic beverage constituent, such as the Brix value, can be provided on the input to the collecting tank 5.

FIG. 2B shows a state when the mixed beverage 3 moves into the following treatment unit, here the preflow tank 23 and the heat exchanger 24. The concentrate 9 and the water 15 are mixed as previously described and passed through the treatment unit 23, 24 until the pipe system carrying the product is filled to the input of the sterile buffer tank 11 with the prepared mixed beverage 3 and heat-treated beverage 3′. In this connection the product water 15 is ejected and passed into the collecting tank 5.

FIG. 2C shows a first production phase in which the mixed phase 7 from the collecting tank 5 is added to the concentrate 9. Optionally, water 15 from the water feed line 35 can be added, as indicated here with a broken line, in order to adjust the target concentration KA on the measurement device 33 on the outlet end. The measurement device 19 is here illustrated for simplicity without the circulation circuit.

FIG. 2D shows a second production phase in which for example the content of incorrectly filled bottles is passed from the catchment tank 13 to the collecting tank 5. Through this introduction of prepared mixed beverage 3″ into the mixed phase 7, the concentration KM of the mixed phase 7 changes in comparison to the first production phase. Accordingly, the volume flow VM of the added mixed phase 7 is adapted to the concentration KM measured in each case with the measurement device 19 and where required, as indicated with a broken line, water 15 is added to adjust the concentration KA in the product line 21 on the outlet end.

FIG. 2E illustrates a third production phase with an empty collecting tank 5 after the mixed phase 7 has been exhausted. In this case the concentration KA is only adjusted by the addition of water 15 from the water feed line 35 to the concentrate 9.

As FIGS. 2C to 2E also show, the prepared mixed beverage 3 is in each case passed continuously to the treatment unit 23, 24 and to the following sterile buffer tank 11. The mixing of the beverage 3 thus preferably occurs continuously, whereby the volume flow of the added mixed phase 7 and/or of the water 15 can be continually adapted to the measured concentrations KK and KM and to the volume flow VK of the concentrate 9. Reusing the mixed phase 7 in running operation is therefore possible without having to interrupt the mixing of the beverage 3. For control of the treated beverage 3′ a further measurement device 49 can be provided before the sterile buffer tank 11 for measuring the concentration of the characteristic value KA, such as the Brix value.

FIG. 2F illustrates a state at the end of the production, after the pipe system of the device 1 has been flushed again with water 15 to remove residues of the concentrate 9 and the mixed beverage 3 from the pipes, to collect them in the collecting tank 5 and to pass them for reuse during later production. The beverage residues retained in the collecting tank 5 are passed to a reservoir container 51 and can be passed again to the mixed phase 7 during the production of another production charge.

Thus, the device according to the disclosure and the method according to the disclosure facilitate essentially complete return of already mixed beverage 3 into the production circulation so that losses due to product change or production interruptions can be reduced, particularly in the bottling of small amounts.

In particular, in the mixed phase 7 proportions of the prepared mixed beverage 3, of the premixed concentrate or basic ingredient 9 and of the water 15 can be retained during introduction of the concentrate 9 into the pipe system, on ejection of the prepared mixed beverage 3 and of the heat-treated beverage 3′, during the return of inadequately sterilized beverage 3′, at the end of production, during a production changeover and during the reuse of already filled beverage 3″.

It is self-evident that not all possibilities of return need to be exploited. For example, a return from the product line 21 could be provided and/or from the sterile buffer tank 11. It is decisive that previously mixed beverage 3, 3′, 3″ can be returned into the production circulation, whereby the combination of a basic component 9 with higher concentration than the end product 3, 3′, 3″ is combined with the diluted mixed phase 7 of the end product 3, 3′, 3″ in a suitable mixing ratio.

1. Device for mixing a beverage, in particular with return of a proportion of the prepared mixed beverage, comprising:
a collecting tank for collecting an aqueous mixed phase, in which the recipe constituents needed for mixing the beverage are contained and which has a higher water content than the mixed beverage;
a product line for providing a concentrate, in which the recipe constituents needed for mixing the beverage are contained and which has a lower water content than the mixed beverage; and for conveying the mixed beverage;
a measurement device for measuring the concentrate (KM) of a characteristic constituent of the mixed phase; and
an additive line connected to the collecting tank and the product line for adding the mixed phase to the concentrate, wherein a dosing device for adjusting the volumetric mixing ratio of the mixed phase and the concentrate is provided on the additive line.

2. Device according to claim 1, wherein a circulation line for circulating the mixed phase is provided on the collecting tank.

3. Device according to claim 2, wherein the measurement device is arranged such that it can measure the concentration (KM) in the circulated mixed phase.

4. Device according to claim 1, and a measurement device on the inlet end for measuring the concentration (KK) of the characteristic constituent of the concentrate and/or with a measurement device on the outlet end for measuring the concentration (KA) of the characteristic constituent of the prepared mixed beverage.

5. Device according to claim 4, and a control device for controlling the dosing device based on a concentration value (KK, KA) of the characteristic constituent determined by the measurement device at the inlet end and/or at the outlet end.

6. Device according to claim 1, and a return line for returning prepared mixed beverage from from the product line to the collecting tank.

7. Device according to claim 1, and a return line for returning prepared mixed beverage and heat-treated beverage from a sterile buffer tank to the collecting tank.

8. Device according to claim 1, and a catchment device, which can be connected to the collecting tank, for collecting and returning prepared mixed beverage filled in bottles or similar containers.

9. Method of mixing a beverage, in particular with the use of a returned proportion of the prepared mixed beverage, comprising:
a) collecting an aqueous mixed phase, in which the recipe constituents needed for mixing the beverage are contained and which has a higher water content than the beverage to be mixed;
b) providing a concentrate, in which the recipe constituents needed for mixing the beverage are contained and which has a lower water content than the beverage to be mixed;
c) measuring the concentration (KM) of a characteristic constituent of the mixed phase; and
d) mixing of the beverage by adding the mixed phase to the concentrate, wherein the volumetric mixing ratio of the mixed phase and the concentrate are adjusted in dependence of the concentration (KM) measured in step c) in order to adjust the concentration (KA) of the characteristic constituent in the mixed beverage to a target value.

10. Method according to claim 9, wherein in step d), adapting a volume flow (VM) of the added mixed phase to a volume flow (VK) of the provided concentrate.

11. Method according to claim 9, in which in step d), adding water to adjust the target value in the mixed beverage.

12. Method according to claim 9, in which in step a), returning prepared mixed beverage from a sterile buffer tank and/or a catchment tank for emptying filled containers into the mixed phase.

13. Method according to claim 9, in which the concentration (KM) measured in step c) is a sugar content.

14. Method according to claim 9, and measuring the concentration (KK) of the characteristic constituent in the beverage concentrate and/or the concentration (KA) of the characteristic constituent in the beverage mixed in step d).

15. Method according to claim 9, and bringing together the concentrate and the mixed phase as continuous flowing dosing lines when the beverage is mixed.

16. Method according to claim 13, wherein the sugar content is a Brix value.
